(19) United States
(12) Patent Application Publication
(10) Pub. No.: US 2011/0058728 A1
(43) Pub. Date: Mar. 10, 2011

(54) Device and Method for Automatic Detection of Dynamic Processes of Cells in Cell Samples

(76) Inventor: Petra Perner, Leipzig (DE)

(21) Appl. No.: 12/869,784

(22) Filed: Aug. 27, 2010

(30) Foreign Application Priority Data
Aug. 28, 2009 (DE) 10 2009 039 649.7
Aug. 28, 2009 (DE) 20 2009 011 850.9

(51) Int. Cl. G06K 9/00

(52) U.S. Cl. 382/133

(57) ABSTRACT

A device for detecting dynamic processes of cell samples has a camera and a data processing system with a first module recognizing the cells of a first image, a second module allocating an identity to the cells, a third module allocating a frame to cells of the first image with one cell in the frame. First, second and third modules are serially connected. A fourth module recognizes cells within frames and allocates identities of cells of the subsequent image and determines similarity of cells relative to cells detected in predecessor images; cells most similar to predecessor cells are assigned as successors; newly added cells are assigned new identities. A fifth module allocates frames for cells of the subsequent image with one cell in the frame. Fourth and fifth modules are a loop for images following the first image. Data memory and data display for images with recognized cells are provided.

### BACKGROUND OF THE INVENTION

### The Invention Concerns

devices and methods for automatic detection of dynamic processes of cells of cell samples with a device for recording in temporal sequence images of the cell sample and a data processing system for recognition and determination of the cells of the cell sample,

a computer program product with a program code for performing a method for automatic detection of the dynamic processes of cells of cell samples from temporally sequential recordings of images of the cell sample and for the recognition and determination of the cells of the cell sample and

a digital storage medium which can interact such with a programmable computer system that a method for the automatic detection of the dynamic processes of cells of cell samples from temporally sequential recordings of images of the cell sample and for the recognition and determination of the cells of the cell sample is performed.

Arrangements for the automatic examination of cells, cell complexes and other biological samples according to the data to be determined are known.

In the publication DE 196 16 997 A1 a method is disclosed for the automated microscope-supported examination of tissue samples or body liquid samples wherein through the application of neural networks tissue samples or body liquid samples are examined in regard to cell types.

An automatic method for the recognition of cell patterns is disclosed in the publication DE 198 01 400 C2. Here, only the shapes in the images are recognized. These publications contain for the examination only of one image of a suitable sample. Conclusions regarding a development of the sample itself are not provided for.

In the publication DE 199 19 539 C1 a method is disclosed for the measurement of the activity of a biologically active substance in a histologic preparation. In this connection, the preparation together with the reagents that change the respective optical property of the preparation based on the activity of the substance to be measured is arranged in front of the image recording device. The substance to be measured causes a change of the optical property in that area of the preparation in which the substance to be measured exists. If several images of the preparation are recorded successively, the changes of the optical property over time can be recognized in this area of the preparation. The rate of change of the optical property relates to the concentration of the substance in a preknown proportional ratio. In this way, a graphic representation of substance concentrations is obtained. Recognizing single objects in the image is not a subject matter addressed in this publication.

The publication DE 197 09 348 A1 discloses an automatic multi-epitope-ligand mapping system. This is based on the recording of an object in its temporal development stages and the overlapping of these recordings of the object to a highly complex molecular combination pattern. The latter shows as a result the temporal development of the object in accordance with given markings in the image. Only one image recording occurs by means of an image record device.

A device for performing biotests is disclosed in the publication DE 198 45 883 A1. This device has means for the automatic image-analytical analysis of biological samples arranged in test receptacles with and without the influence of potentially phytotoxic substances in different matrices and an optical recording device that illuminates the test receptacle with reflected light or transmitted light, flattens the samples if necessary with a glass plate or a highly polar matrix, records it with a digital camera and transmits the data for reduction and evaluation to an image analysis system. The realization, the function and the features of the image analysis system are not discussed in this publication.

The publication DE 101 28 552 A1 discloses a method for the cell analysis and a cell analysis device. For this purpose, the cells to be analyzed are applied to a support so as to adhere and are stained by means of a first staining agent. The cells stained in this way are digitally recorded and saved. Then the same cells are treated with a second staining agent whereupon the optically measurable properties change. Then a second digital image is generated and saved. The method and the device are limited to the analysis of cells that change their optical properties as a result of the action of staining agents.

From the publication DE 38 36 716 A1 a method is known for the analysis of cell images. This method concerns an interactive method wherein a plurality of different adjoining image fields of a cell culture are recorded in chronologic sequence several times and are saved as digital images. Subsequently, the chronologically recorded digital images of an image field are displayed successively on the monitor screen and the cells in the image field are marked; different markings are provided for different cell models and cell generations. Subsequently, from the saved number and positions of the markings the statistical characteristics are determined that are typical for the cells in the image fields or the cell culture. This relates to a part-automatic method. The cells to be evaluated must be marked in each first partial image of the chronological sequence by the user. Automatic object recognition in the image does not occur.

The publication DE 42 11 904 A1 discloses a method and a device for generating a list of species for a liquid sample. The device has an image recording device for optical acquisition of the sample resulting from image data. Further a localization device is provided for recognizing and localizing the objects in the recorded image data as well as an identification device. The device has furthermore a counting device for counting the identified objects according to the respective species as well as for registering the counted objects in the list of species. In this connection, the identification device encompasses a searching device that compares the localized objects to a group of reference objects that, on the basis of coarse features gained from the image data of the localized object, are obtained from a larger group of reference objects. In this connection, the main focus is on ascertaining the objects in the digital images and their allocation to the list of species. A dynamic assessment of objects in the sample is not a subject matter addressed in this publication.

A method is disclosed in the publication U.S. Pat. No. 5,914,245 A for acquiring the dynamic processes in enzymes. Single image points are evaluated that are distinguished by absorption or fluorescence or are located in a grid. Single objects are not acquired.

The publication WO 2007/101 706 A1 reveals a method for the determination of molecules or molecule parts in biological samples. The sample is provided for this purpose with a light-emitting marker. The light emission caused thereby is measured subsequently. Inherent light emission is reduced or is eliminated by means of bleaching. Single objects are not determined.

The publication WO 03/050 535 A2 discloses a method for the determination of effects of non-physiological compounds, their derivatives and decomposition products on organisms, organs and cells. For this purpose, optical markers are used for marking molecules. These markers are distinguishable according to the molecules. The main focus is directed to bleaching after use of a marker in order to obtain upon use of a new marker optical signals that can be evaluated.

### SUMMARY OF THE INVENTION

The invention has the object to automatically detect the dynamic processes of cells of cell samples in a simple way.

This object is solved with a device for the automatic detection of the dynamic processes of cells of cell samples with a device for recording in temporal sequence images of the cell sample and a data processing system for the recognition and determination of the cells of the cell sample that is characterized in particular in that a simple automatic detection is provided.

In this connection in the data processing system

a) a first module for the recognition of the cells of the cell sample of the first image,

b) a second module for the allocation of an identity for each of the cells,

c) a third module for the allocation of a frame for each of the cells of the first image in the form of a search box, wherein in the frame only one cell is located so that the frame and with it the size of the search box is determined by neighboring cells, are realized. The first module, the second module, and the third module are connected in series in the data processing system.

Furthermore, in the data processing system

d) a fourth module

for the recognition of the cells within the frames in the form of the search boxes with allocation of the respective identity of the cells of the subsequent image and

for pairwise determination of the similarity of the cells relative to the cells detected in the search box of the respective predecessor image, wherein, on the basis of a similarity value, the cell that is most similar to the cell of the predecessor cell is assigned as a successor, respectively, and newly added cells are assigned a new identity, respectively, and

e) a fifth module for the allocation of a frame in the form of a search box for each of the cells of the subsequent image, so that in the frame only one cell is located and the frame and with it the size of the search box is determined by neighboring cells, are realized.

The fourth module and the fifth module are connected downstream of the third module and are a loop for all images following the first image.

In addition, the data processing system is connected with a data memory, a data display unit, or a data memory as well as a data display unit for the images with the recognized cells including their respectively assigned identity, their distances, their positions and their paths.

The data processing system is a known computer. The individual modules are embodied in the form of the data processing device of the computer and areas of memories linked therewith. With it, also the method for the automatic detection of the dynamic processes of cells of cell samples is performed.

Moreover, the object of the invention is solved also by a method for the automatic detection of the dynamic processes of cells of cell samples from temporally sequential recordings of images of the cell sample with the following steps:

a) recognition of the cells of the cell sample of the first image,

b) allocation of an identity for each of the cells,

c) allocation of a frame for each of the cells of the first image in the form of a search box wherein in the frame only one cell is located so that the frame and with it the size of the search box is determined by neighboring cells,

d) recognition of the cells within the frames in the form of the search boxes with allocation of the respective identity of the cells of the respective subsequent image,

e) pairwise determination of the similarity of the cells relative to the cells detected in the search box of the respective predecessor image,

f) respective allocation of the cell that is most similar to the cell of the predecessor on the basis of a similarity value as a successor, and

g) allocation of a new identity to newly added cells,

h) allocation of a frame in the form of a search box for each of the cells of the respective subsequent image so that in the frame only one cell is located and the frame and with it the size of the search box is determined by neighboring cells,

wherein the steps a) to c) successively and the steps d) to h) are a loop for all images following the first image.

Furthermore, the object of the invention is solved by a computer program product with a program code for performing a method for the automatic detection of the dynamic processes of cells of cell samples from temporally sequential recordings of images of the cell sample and for the recognition and determination of the cells of the cell sample with the following steps:

a) recognition of the cells of the cell sample of the first image,

b) allocation of an identity for each of the cells,

c) allocation of a frame for each of the cells of the first image in the form of a search box, wherein in the frame only one cell is located so that the frame and with it the size of the search box is determined by neighboring cells,

d) recognition of the cells within the frames in the form of the search boxes with allocation of the respective identity of the cells of the respective subsequent image,

e) pairwise determination of the similarity of the cells relative to the cells detected in the search box of the respective predecessor image,

f) respective allocation of the cell most similar to the cell of the predecessor on the basis of a similarity value as a successor, and

g) allocation of a new identity to newly added cells,

h) allocation of a frame in the form of a search box for each of the cells of the respective subsequent image so that in the frame only one cell is located and the frame and with it the size of the search box is determined by neighboring cells,

wherein the steps a) to c) successively and the steps d) to h) are a loop for all images following the first image, available when the program is running on a computer with the thereby appropriately implemented modules.

The object of the invention is furthermore solved by a digital storage medium which can interact with a programmable computer system. The digital storage medium is embodied for this purpose advantageously such that a method for the automatic detection of the dynamic processes of cells of cell samples from the temporally sequential recordings of images of the cell sample and for the recognition and determination of the cells of the cell sample with the following steps:

a) recognition of the cells of the cell sample of the first image,

b) allocation of an identity for each of the cells,

c) allocation of a frame for each of the cells of the first image in the form of a search box wherein in the frame only one cell is located so that the frame and with it the size of the search box is determined by neighboring cells,

d) recognition of the cells within the frames in the form of the search boxes with allocation of the respective identity of the cells of the respective subsequent image,

e) pairwise determination of the similarity of the cells relative to the cells determined in the search box of the respective predecessor image,

f) respective allocation of the cell most similar to the cell of the predecessor on the basis of a similarity value as a successor, and

g) allocation of a new identity to newly added cells,

h) allocation of a frame in the form of a search box for each of the cells of the respective subsequent image so that in the frame only one cell is located and the frame and with it the size of the search box is determined by neighboring cells,

wherein the steps a) to c) successively and the steps d) to h) are a loop for all images following the first image, is performed in a device realized therewith.

Similarity values are determined, for example, from the determination of the Euclidean distance values, the Mahalanobis distance values or the Zamperoni distance values. In this connection, the cells are determined by their surface areas and their grey scale values or color values.

A data processing system is realized by the computer program product and the digital storage medium as a device for the automatic detection of the dynamic processes of cells of cell samples.

The devices, processes, computer program products and digital storage media are characterized in particular in that developments of the cell sample can be automatically detected and can be followed up on. Advantageously, for this purpose the positions and their changes are automatically acquired. The results are saved in a data memory so that they are available any time again for another processing, further processing or post evaluation. In addition, the results can be displayed on a data display unit. This occurs including their respectively assigned identity, their distances, their positions and their paths. A temporal development can be followed easily. Furthermore, a development of cells is included. In addition to a change of location of the cells also movements that are not changes in location can be detected. These are in particular rotations of the cells.

Another advantage resides in that the module for the recognition is a module for allocating a new identity to newly added cells for detecting the cells of the subsequent image. In this connection, initially invisible cells are also encompassed in the examination and observation of the cell sample.

Advantageous embodiments of the invention are disclosed in the dependent claims.

According to one embodiment, the module for recognition is a module that recognizes entire, fragmented, touching and overlapping cells for recognition of the cells of the cell sample. By means of the sizes of the determined surface areas of the cells a classification in entire, fragmented, touching and overlapping cells is possible. As a result cells that are fragmented, touching and overlapping can thus be removed so that only entire cells are included for the automatic detection of the dynamic processes of cells of cell samples. Accordingly, unequivocal statements about the temporal development of the cell sample can be made.

The module for recognition is according to one embodiment a module that assigns in case of dividing cells the identity of the mother cell to the divided cells for the recognition of the cells of the subsequent image. The divided cells are assigned advantageously the identity of the mother cell so that the division and the development of the divided cells can be followed with respect to time and location.

The cell is determined according to another embodiment by the contour, the texture, or the contour as well as the texture.

The module for recognition is according to one embodiment a module for recognition that determines the similarity of the cell relative to the cell in the search box of the predecessor image, wherein

the predecessor image of the cell with its identity is an image sequence as a pyramid with image planes,

a gradient image of the successor image is generated with retention of the identity and is transferred into an image sequence as a pyramid with image planes,

the successor image is successively shifted onto each predecessor image of the gradient image beginning with the highest image planes so that the successor image is compared to every predecessor image of the gradient image,

the successor image is aligned relative to the predecessor image such that in this connection a scaling and/or rotation of the successor image is carried out,

while at the same time the similarity is calculated,

during the calculation of the similarity the similarity values are determined either as distance values or as similarity values between the successors image and the predecessors image, respectively, until either a minimum of the distance values or a maximum of the similarity values exists, and

the degree of correspondence between successor image and predecessor image based on the similarity value is determined such that the degree of correspondence decreases with decreasing similarity value and the predecessor image becomes less similar to the successor image.

The selected image of the cell and the generated gradient image are transferred into pyramids with image planes. The individual image planes are compared successively with each other wherein the highest image planes are the starting point. The highest image planes are the least sharp image planes with the smallest amount of data each so that the comparison is carried out beginning with minimum computing expenditure. During the comparison between the predecessor image and the successor image of the cell an adjustment and/or scaling and/or rotation of the successor image occurs and, at the same time, advantageously also the similarity is calculated in this connection.

The special advantage resides in that either the contour or the shape can be digitally acquired and saved. Based on these data, manipulations can be carried out subsequently, wherein, for example, similarity values are determinable and the similarity and/or the similarity as a degree of correspondence between predecessor and successor images can be described by the similarity value. With decreasing similarity value the successor image is less similar to the predecessor image.

The module for recognition is according to one embodiment a module that detects the cell by edge detection.

In this connection, advantageously the gradient image is generated by edge detection of the cell wherein big changes of the grey scale value in vertical as well as in horizontal direction are assigned gradients in each case and homogeneous surfaces have no gradient assigned. The homogeneous surfaces are black. The result is an image with white edges of the cell, while the surfaces enclosed by the edges of the cell and the surfaces adjoining the edges of the cell are black. The data quantity of the digital image is thereby substantially lower in comparison to a grey scale value image of the digital image. At the same time the computing expenditure decreases when comparing the cells by means of calculation of the similarities with the determination of similarity values.

The data processing system according to one embodiment is a data processing system that detects the distances, the positions and the path of cells in the image of the cell sample. The temporal development of the cell sample including its cells can therefore be followed easily.

### DESCRIPTION OF THE PREFERRED EMBODIMENTS

Embodiments of the invention are described in the following in more detail.

In the following a device and a method for the automatic detection of the dynamic processes of cells of cell samples are explained together in more detail.

A device for the automatic detection of the dynamic processes of cells of cell samples consists in a first embodiment essentially of a device for recording in temporal sequence images of the cell sample and a data processing system for recognition and determination of the cells of the cell sample.

The device for recording is in this connection a known digital camera that acquires images of the cell sample by using temporal control. The images of the cell sample are converted by the digital camera at the same time into digital data and are saved in a data medium with assignment of the time. For enlarging the image of the cell sample, a microscope can be arranged in front of the recording device.

The digital camera or the data memory with the data of the images is connected with the data processing system for further processing the data.

For this purpose, in the data processing system

a) a first module for the recognition of the cells of the cell sample of the first image,

b) a second module for the allocation of an identity for each of the cells,

c) a third module for the allocation of a frame for each of the cells of the first image in the form of a search box, wherein in the frame only one cell is located so that the frame and with it the size of the search box is determined by neighboring cells,

d) a fourth module

for the recognition of the cells within the frames in the form of the search boxes with allocation of the respective identity of the cells of the subsequent image and

for pairwise determination of the similarity of the cells relative to the cells detected in the search box of the respective predecessor image, wherein, on the basis of a similarity value, the cell that is most similar to the cell of the predecessor cell is assigned as a successor, respectively, and newly added cells are assigned a new identity, respectively, and

e) a fifth module for the allocation of a frame in the form of a search box for each of the cells of the subsequent image, so that in the frame only one cell is located and the frame and with it the size of the search box is determined by neighboring cells, are arranged.

The first module, the second module and the third module are serially connected in succession in the data processing system. With this arrangement the cells of the first image are recognized and an identity is assigned to the cells, respectively. In this connection, the identity is a description and/or numbering of the cell.

The fourth module and the fifth module are connected downstream of the third module and are a loop for all images following the first image. As a result of the recognition of the cells their number and their positions can be determined at the same time in the image. By means of the frames that are arranged locally and predetermined dimensionally, the distances and the positions of the cells of the subsequent images can also be determined in dependence of the respective predecessor image, so that the path of cells in the image of the cell sample can be followed.

The module for the recognition in the data processing system is embodied furthermore such

that entire, fragmented, touching and overlapping cells of the cell sample are recognized,

that dividing cells are assigned the identity of the mother cell so that the division is recognized and the development of the divided cells can be followed,

that a new identity is assigned to newly added cells, respectively,

that the similarity of the cell is determined relative to the cell in the search box of the predecessor image wherein the similarity is also determined based on rotation and/or the texture of the cell.

When determining the similarity

the predecessor image of the cell with its identity is an image sequence as a pyramid with image planes,

a gradient image of the successor image is generated with retention of the identity and is transferred into an image sequence as a pyramid with image planes,

the successor image is shifted successively onto each predecessor image of the gradient image beginning with the highest image planes wherein the successor image is compared to every predecessor image of the gradient image,

the successor image is aligned on the predecessor image such that in this connection a scaling and/or rotation of the successor image is carried out,

the similarity is calculated at the same time,

the similarity values are determined during the calculation of the similarity either as distance values or as similarity values between the successor image and the predecessor image, respectively, until either a minimum of the distance values or a maximum of the similarity values exists, and

the degree of correspondence between successor image and predecessor image is determined by the similarity value such that the degree of correspondence with decreasing similarity value decreases and the predecessor image becomes less similar to the successor image.

The cells of the images of the cells are recognized advantageously by edge detection in the module for recognition. Aside from the outer edge of the cell, also inner edges of the cell can be recognized so that also the texture of the cell can be determined.

The data processing system is connected furthermore with a data memory, a data display unit in the form of a monitor screen, or a data memory and a data display unit for the images with the recognized cells including their respectively assigned identity. Of course, a printer can be connected also.

A computer program product in a second embodiment is a computer program product with a program code for performing a method for the automatic detection of the dynamic processes of cells of cell samples from the temporally sequential recordings of images of the cell sample and for the recognition and determination of the cells of the cell sample with the following steps

a) recognition of the cells of the cell sample of the first image,

b) allocation of an identity for each of the cells,

c) allocation of a frame for each of the cells of the first image in the form of a search box, wherein in the frame only one cell is located so that the frame and with it the size of the search box is determined by neighboring cells,

d) recognition of the cells within the frames in the form of the search boxes with allocation of the respective identity of the cells of the respective subsequent image,

e) pairwise determination of the similarity of the cells relative to the cells detected in the search box of the respective predecessor image,

f) respective allocation of the cell most similar to the cell of the predecessor on the basis of a similarity value as a successor, and

g) allocation of a new identity to newly added cells,

h) allocation of a frame in the form of a search box for each of the cells of the respective subsequent image, so that in the frame only one cell is located and the frame and with it the size of the search box is determined by neighboring cells,

wherein the steps a) to c) successively and the steps d) to h) are a loop for all images following the first image, when the program is running on a computer with the modules appropriately implemented thereby.

A digital storage medium in a third embodiment is a digital storage medium which can interact in such a way with a programmable computer system that a method for the automatic detection of the dynamic processes of cells of cell samples from the temporally sequential recordings of images of the cell sample and for the recognition and determination of the cells of the cell sample with the following steps

a) recognition of the cells of the cell sample of the first image,

b) allocation of an identity for each of the cells,

c) allocation of a frame for each of the cells of the first image in the form of a search box, wherein in the frame only one cell is located so that the frame and with it the size of the search box is determined by neighboring cells,

d) recognition of the cells within the frames in the form of the search boxes with allocation of the respective identity of the cells of the respective subsequent image,

e) pairwise determination of the similarity of the cells relative to the cells detected in the search box of the respective predecessor image,

f) respective allocation of the cell most similar to the cell of the predecessor on the basis of a similarity value as a successor, and

g) allocation of a new identity to newly added cells,

h) allocation of a frame in the form of a search box for each of the cells of the respective subsequent image, so that in the frame only one cell is located and the frame and with it the size of the search box is determined by neighboring cells,

wherein the steps a) to c) successively and the steps d) to h) are a loop for all images following the first image, when the program is running on a computer with the modules appropriately implemented thereby.

What is claimed is:

1. A device for the automatic detection of the dynamic processes of cells of cell samples comprising:
a device for the temporal sequential recording of images of the cell sample;
a data processing system for the recognition and determination of the cells of the cell sample, the data processing system comprising:
a) a first module for the recognition of the cells of the cell sample of the first image,
b) a second module for the allocation of an identity for each of the cells,
c) a third module for the allocation of a frame for each of the cells of the first image in the form of a search box, wherein in the frame only one cell is located so that the frame and with it the size of the search box is determined by neighboring cells,
wherein the first module, the second module and the third module are serially connected in succession in the data processing system,
d) a fourth module
for the recognition of the cells within the frames in the form of the search boxes with allocation of the respective identity of the cells of the subsequent image and
for the pairwise determination of the similarity of the cells relative to the cells detected in the search box of the respective predecessor image, wherein, on the basis of a similarity value, the cell that is most similar to the cell of the predecessor is assigned as a successor, respectively, and the newly added cells are assigned a new identity, respectively,
e) a fifth module for the allocation of a frame in the form of a search box for each of the cells of the subsequent image, so that in the frame only one cell is located and the frames and with it the size of the search box is determined by neighboring cells,
wherein the fourth module and the fifth module are connected downstream of the third module and are a loop for all images following the first image;
a data memory, a data display unit or a data memory as well as a data display unit for the images with the recognized cells including their respectively assigned identity, their distances, their positions and their paths.

2. The device according to claim 1, wherein the module for recognition is adapted to recognize entire, fragmented, touching and overlapping cells.

3. The device according to claim 1, wherein the module for recognition is adapted to recognize the cells of the subsequent image and assigns in case of dividing cells the identity of the mother cell to the divided cells.

4. The device according to claim 1, wherein the cell is determined by the contour, the texture, or the contour as well as the texture.

5. The device according to claim 1, wherein the module for recognition determines the similarity of the cell relative to the cell determined in the search box of the predecessor image, wherein
the predecessor image of the cell with its identity is an image sequence as a pyramid with image planes,
a gradient image of the successor image is generated with retention of the identity and is transferred into an image sequence as a pyramid with image planes,
the successor image successively is shifted onto every predecessor image of the gradient image beginning with the highest image planes so that the successor image is compared to every predecessor image of the gradient image,
the successor image is aligned on the predecessor image such that in this connection a scaling and/or rotation of the successor image is carried out,
in this connection, the similarity is calculated at the same time,
during the calculation of the similarity, the similarity values are determined either as distance values or as similarity values between the successor image and the predecessor image, respectively, until either a minimum of the distance values or a maximum of the similarity values exists, and
the degree of correspondence between successor image and predecessor image is determined by the similarity value such that the degree of correspondence with decreasing similarity value decreases and the predecessors image becomes less similar to the successor image.

6. The device according to claim 1, wherein the module for recognition recognizes the cell by edge detection.

7. The device according to claim 1, wherein the data processing system determines the distances, the positions and the path of cells in the image of the cell sample.

8. A method for the automatic detection of the dynamic processes of cells of cell samples from temporally sequential recordings of images of the cell sample with the following steps:
a) recognition of the cells of the cell sample of the first image,
b) allocation of an identity for each of the cells,
c) allocation of a frame for each of the cells of the first image in the form of a search box wherein in the frame only one cell is located so that the frame and with it the size of the search box is determined by neighboring cells,
d) recognition of the cells within the frames in the form of the search boxes with allocation of the respective identity of the cells of the respective subsequent image,
e) pairwise determination of the similarity of the cells relative to the cells determined in the search box of the respective predecessor image,
f) respective allocation of the cell most similar to the cell of the predecessor on the basis of a similarity value as a successor and
g) allocation of a new identity to newly added cells,
h) allocation of a frame in the form of a search box for each of the cells of the respective subsequent image so that within the frame only one cell is located and the frame and with it the size of the search box is determined by neighboring cells,
wherein the steps a) to c) are performed successively and the steps d) to h) form a loop for all images following the first image.

9. A computer program product with a program code for performing a method for the automatic detection of the dynamic processes of cells of cell samples from temporally sequential recordings of images of the cell sample and for the recognition and determination of the cells of the cell sample with the following steps:
a) recognition of the cells of the cell sample of the first image,
b) allocation of an identity for each of the cells,
c) allocation of a frame for each of the cells of the first image in the form of a search box wherein in the frame only one cell is located so that the frame and with it the size of the search box is determined by neighboring cells,
d) recognition of the cells within the frames in the form of the search boxes with allocation of the respective identity of the cells of the respective subsequent image,
e) pairwise determination of the similarity of the cells relative to the cells determined in the search box of the respective predecessor image,
f) respective allocation of the cell that is most similar to the cell of the predecessor on the basis of a similarity value as a successor and
g) allocation of a new identity to newly added cells,
h) allocation of a frame in the form of a search box for each of the cells of the respective subsequent image so that within the frame only one cell is located and the frame and with it the size of the search box is determined by neighboring cells,
wherein the steps a) to c) are performed successively and the steps d) to h) form a loop for all images following the first image, when the program is running on a computer with the modules appropriately realized thereby according to claim 1.

10. A digital storage medium adapted to interact in such a way with a programmable computer system that a method for the automatic detection of the dynamic processes of cells of cell samples from temporally sequential recordings of images of the cell sample and for the recognition and determination of the cells of the cell sample with the following steps:
a) recognition of the cells of the cell sample of the first image,
b) allocation of an identity for each of the cells,
c) allocation of a frame for each of the cells of the first image in the form of a search box wherein in the frame only one cell is located so that the frame and with it the size of the search box is determined by neighboring cells,
d) recognition of the cells within the frames in the form of the search boxes with allocation of the respective identity of the cells of the respective subsequent image,
e) pairwise determination of the similarity of the cells relative to the cells determined in the search box of the respective predecessor image,
f) respective allocation of the cell that is most similar to the cell of the predecessor on the basis of a similarity value as a successor and
g) allocation of a new identity to newly added cells,
h) allocation of a frame in the form of a search box for each of the cells of the respective subsequent image so that within the frame only one cell is located and the frame and with it the size of the search box is determined by neighboring cells,
wherein the steps a) to c) are performed successively and the steps d) to h) form a loop for all images following the first image,
is carried out in a device according to claim 1.
